(19) United States
(12) Patent Application Publication
(10) Pub. No.: US 2005/0222896 A1
(43) Pub. Date: Oct. 6, 2005

(54) Systems, methods, and software for leveraging informational assets across multiple business units

(76) Inventors: Joseph Council Rhyne, Little Silver, NJ (US); Stephen Hall, Manchester, MA (US); Christopher Crowhurst, Whitehall, MD (US); Francis L. J. Fuca, St. Paul, MN (US); Christopher T. Wolff, Woodbury, MN (US)

Correspondence Address: Schwegman, Lundberg, Woessner & Kluth, P.A., P.O. Box 2938, Minneapolis, MN, 55402, US

(21) Appl. No.: 10/945,534

(22) Filed: Sep. 20, 2004

Related U.S. Application Data
(60) Provisional application No. 60/504,354, filed on Sep. 19, 2003.

(51) Int. Cl. G06F 17/60

(52) U.S. Cl. 705/10

(57) ABSTRACT

One problem recognized by the present inventors is that even in highly successful companies, such as those in the Thomson corporate family, information and solutions provided by one business unit are not readily combined or integrated with those provided by other business units. Accordingly, the present inventors devised, among other things, a computerized implementation of a federated business model and architecture for the creation of integrated information solutions from content sets and service offerings provided by multiple business units. The exemplary system includes a catalog module that facilitates identification of informational assets, such as products, services, and content, that are created by multiple business units; a collaborative infrastructure to facilitate aggregation or integration of two or more informational assets into a new informational asset; and a settlement module for handling one or more financial and accounting aspects of the asset integration.

### RELATED APPLICATION

This application claims priority to U.S. Provisional Application 60/504,354, which was filed on Sep. 19, 2003 and which is incorporated herein by reference.

### COPYRIGHT NOTICE AND PERMISSION

One or more portions of this patent document contain material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2003, Thomson Corporation.

### TECHNICAL FIELD

Various embodiments of the present invention concern management and distribution systems for information and software.

### BACKGROUND

The 1990s witnessed a rapid roll out of computer technology into homes and businesses. During this time, computers, fueled largely by expansion of the Internet, advanced from facilitating tasks, such as word processing and bookkeeping, to become everyday communications tools nearly as common as telephones and televisions. As a result, virtually every sector of public, private, and commercial life has been affected in some significant way by the power and reach of today's computer technology.

This is especially true for businesses that provide information to other businesses. For example, businesses, such as Thomson Legal & Regulatory which provides legal information to lawyers and judges, Thomson Financial which provides financial data to stock brokers and asset managers, Thomson Scientific & Healthcare which provides scientific and medical information to scientists and physicians, and Thomson Learning which provides academic texts and educational materials to teachers, students, and corporate trainers have started viewing and identifying themselves as providers of information solutions, rather than just information.

One problem recognized by the present inventors is that even in successful companies, such as the Thomson sister companies noted above, information and solutions provided by one business unit are not readily combined or integrated with those provided by other business units. Thus, for example, legal information and related software from Thomson Legal & Regulatory are not readily accessed by developers at Thomson Financial for integration with financial information, and vice versa.

Accordingly, the present inventors have identified a need for better ways of leveraging information and related solutions across multiple business units.

### SUMMARY

To address this or one or more other needs, the present inventors have devised one or more systems, methods, and software. One exemplary system provides a computerized implementation of a federated business model and architecture for the creation of integrated information solutions from content sets and service offerings provided by multiple business units. The exemplary system includes a catalog module that facilitates identification of informational assets, such as products, services, and content, that are created by multiple business units; a collaborative infrastructure to facilitate aggregation or integration of two or more informational assets into a new informational asset; and a settlement module for handling one or more financial and accounting aspects of the asset integration.

### BRIEF DESCRIPTION OF DRAWINGS

FIG. 1 is a block diagram of an exemplary system 100, which corresponds to one or more embodiments of the invention.

FIG. 2 is a flow chart which illustrates an exemplary method of operating system 100 and which corresponds to one or more embodiments of the invention.

FIG. 3 is a diagram which illustrates an exemplary method of interacting with a catalog and which corresponds to one or more embodiments of the invention.

FIG. 4 is a diagram which illustrates an exemplary settlement process and which corresponds to one or more embodiments of the invention.

### DESCRIPTION OF EXEMPLARY EMBODIMENTS

This description, which references and incorporates one or more drawings, describes and illustrates one or more exemplary embodiments of the invention. These embodiments, offered not to limit but only to exemplify and teach the concepts of the invention, are shown and described in sufficient detail to enable those skilled in the art to make and use the invention. Thus, where appropriate to avoid obscuring the invention, the description may omit certain information known to those of skill in the relevant art.

### Exemplary System

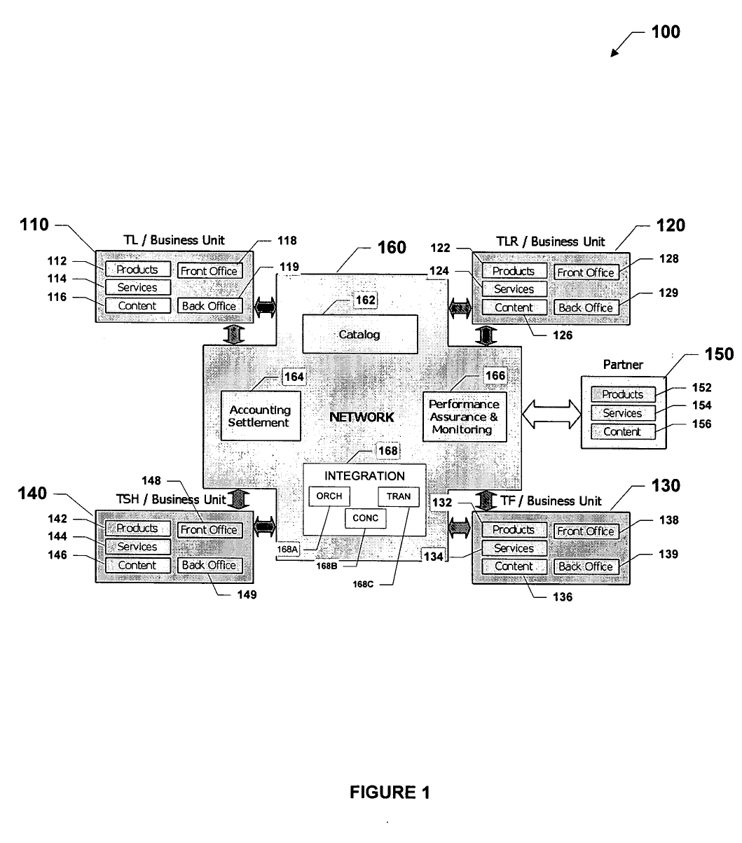

FIG. 1 shows an exemplary integrated, modular, and federated system for allowing multiple business units, including third-party business units, to combine content and/or services (for example, web services or more generally functionality) simply, routinely, and cost effectively. The exemplary allows each centralized or decentralized content production or sourcing entity to acquire and leverage information and/or software objects held by other business units or entities. In some embodiments, the system also facilitates rating and modeling various forms of content or software.

Specifically, system 100 includes a learning business unit 110, a legal and regulatory business unit 120, a financial business unit 130, a scientific and healthcare business unit 140, a partner business unit 150, and a collaborative infrastructure 160.

Learning business unit 110 includes information products 112, web services 114, content (information or data) 116, front-office services 118, and back-office services 119. Similarly, legal and regulatory business unit 120 (legal business unit 120) includes information products 122, web services 124, content (information or data) 126, front-office services 128, and back-office services 129; financial business unit 130 includes information products 132, web services 134, content (information or data) 136, front-office services 138, and back-office services 139; includes information products 142, web services 144, content (information or data) 146, front-office services 148, and back-office services 149; and partner business unit includes information products 152, web services 154, content (information or data) 156, front-office services 158, and back-office services 159.

In the exemplary embodiment, each of the sets of information products 112, 122, 132, 142, and 152 includes respective online information products of business units 110, 120, 130, 140, and 150. For instance, information products 112 includes online information retrieval and presentation software for legal business unit 110, and information products 122 includes online information retrieval and presentation software for financial business unit 120. Each of the sets of web services 114, 124, 134, 144, and 154 includes respective web services (or other software objects) of business units 110, 120, 130, 140, and 150. Each of the sets of content 116, 126, 136, 146, and 156 includes respective content of business units 110, 120, 130, 140, and 150.

Moreover, in the exemplary embodiment, each informational asset conforms to a core set of standards to facilitate usage by other business units. The following standards are used: HTTPS, XML, WSDL, SOAP, MIME. SOAP, or Simple Object Access Protocol provides a standard XML-based encapsulation of requests and responses. WSDL (Web Service Description Language) provides an XML-based method of describing service interfaces. WSDL provides network protocol binding, extensible message definitions, and support for MIME multipart messages. XML (Extensible Markup Language) provides a generic syntax to organize data with simple, human-readable labels. XML Schema provides the capability to define complex XML data structures, including XML namespace support. UDDI (Universal Description, Discover, and Integration) provides a standard means of publishing and discovering web services by company or supported interfaces. UDDI allows clients to examine lists of services that support their standards or interfaces through dynamic searches. HTTP, or Hypertext Transfer Protocol provides a globally accepted communications protocol for data transport. And MIME, or Multipurpose Internet Mail Extensions, provide support for sending a variety of different media across the Internet.

Furthermore, in the exemplary embodiment, each service (and/or content object) includes a standard service interface. The interface is made publicly available in a fashion that conforms to a common specification which is based on a known set of standards. The standards define the core operations required for each service and the means to extend them to include new parameters or even new operations. A client that understands the publicly available interface definition or specification of the assets can exchange messages with any compliant asset. This makes the discovery and use of these services uniform, and thus facilitates integration into the applications and workflows of other business units.

Additionally, each informational asset in the exemplary embodiment, whether it be a product, service, or content, supports single sign on (SSO) functionality to simplify the customer experience and to improve service interoperability. The single-sign-on functionality provides a means for authenticating customers and for exchanging information related to their identity and privileges. In essence, it allows users to log in once to gain access to all services integrated for a given application, and thus avoid multiple logins or sign-ons per session. Thus, even when a customer logins into a user interface provided by one business party and accesses a product, service, or content held by another business unit, but integrated into the offering of the one business party, no further login or sign on is necessary. Some embodiments may signal alternative billing to the consumer for accessing the integrated product, service, or content. In some embodiments, the SSO capability is a generic A&A (authorization and authentication) web service used along side all of these services to provide credentialing. Without first consuming the A&A web service, the others can not be accessed. Other embodiments are not so limited.

Collaborative infrastructure 160, which provides services to connect, exchange and share content, functionality, and products, includes a catalog module 162, a settlement module 164, a performance module 166, and an integration or collaboration module 168, all of which are interconnected via a high-speed, trusted network.

Catalog module 162 includes a registry for discovery and an access mechanism of all services and content enabled for use in the collaborative infrastructure. In the exemplary embodiment, the catalog module encompasses all the products, services, and content of each participating business unit, and features formalized vocabularies and metadata to allow cross-system searches, standard data formats for catalog entries, APIs and web services to allow automated search and retrieval of information. Each informational asset that is exposed in the collaboration environment is registered into the catalog module and is associated with service descriptions, data schema, data dictionaries, and so forth. In addition to this API type of data, considerable information about the content and service, availability, royalty or pricing arrangements and the like are also included to allow product developers from other business units to identify and consume the content and services.

In the exemplary embodiment, catalog module 162 is distributed across the collaborating or participating business units to facilitate decentralized administration, though to users it may appear as a centralized entity. In this embodiment, the module therefore includes pointers to the assets in the business units that host them. However, in some embodiments, the module takes the form of a centralized registry or repository.

Additionally, the exemplary catalog module is organized according to a white, yellow and green-pages paradigm. The white pages facilitates identification of informational assets or resources by name. Thus, for instance, if one knows the name of a resource (product, content, software code, or person), he can use the white pages to find them. The yellow pages organizes available assets by subject, and the green pages organizes the assets via technical details necessary to use the resource or to create a derivative service.

In some other embodiments, catalog module 162 is organized into product, technical, and employee directories. Product directory spans the entire enterprise (or set of participating business units.) Technical directory, which is primarily directed at users who are technologists, includes resources (resource pointers), such as schemas, DTDs (document type definitions), source codes and other tools. Employee directory can include organization charts, skills, project experience and areas of expertise in addition to employee contact data. Some embodiments also include directories for projects, communities, jobs, vendors, policies, and so forth.

Settlement module 164 handles financial and accounting aspects of informational asset transfer and collaboration. Specifically, the settlement module is a collection of services that supports the business back-end of the collaborate infrastructure. It includes tools for retrieving price information on shareable content and reusable services from the collaborating business units and a toolkit for connecting disparate business systems of each business unit. The settlement component includes modules for pricing content and services, tools for recording purchases, and mechanisms for securely communicating purchase information to the source company or business. In some embodiments, the settlement module provides a complete back-end solution, including a general ledger system, and/or invoicing services. Settlement module can reuse existing business unit system functionality by providing an integration layer.

The exemplary embodiment structures the settlement module as a services stack. The stack encompasses functionality from services required to post pricing and settlement information, to discovery services for finding content, content pricing, business contacts, to the mechanisms that will authorize a purchase and enable access of the purchased product, service, or content. Some embodiments enable automatic negotiation for pricing and purchasing of system assets. Exemplary settlement functionality includes the ability to get a price for a product, communicate a purchase request to the owning business unit, and receive confirmation and access to the product.

In some embodiments, the settlement module follows a services-oriented framework and is supported by two logical components: a pricing engine, which provides rule-based price determination; and a transaction controller, which captures purchase information and delivers it to back-end systems at the business units and coordinates authorization and access control.

The transaction controller orchestrates the exchange of information between purchasers and providers, with the guarantee of transactional integrity. The transaction controller also logs purchases and exchanges of products, content, and services.

Performance module 166 monitor performance of integration services, content transfer, and software sharing capabilities to provide assurance the system is working. Specifically, it provides mechanisms to monitor and manage systems, and assures performance, availability, scalability, and reliability. It also provides basic Quality-of-Service (QoS) levels, and management services around web services like: access control, non-repudiation, provisioning, transaction orchestration, security, and so forth. In other embodiments, the performance module includes functionality for reporting in addition to an infrastructure for systems management. Systems management functionality can include monitoring various network infrastructure elements like relays, gateways, routers, switches, applications and providing surveillance services, such as QoS alerting, reporting, service-level-agreement (SLA) monitoring, trending, forecasting, and so forth. In some embodiments, this module also includes a service management function to mitigate the common N2 problem of connecting together N services through a potential N2 number of paths. This function would include features such as service network visualization, root cause failure Analysis, policy definition and deployment, and flexible reporting.

Integration or assembly module 168 facilitates integration or combination of informational assets from or identified in catalog module 162, with other catalogued assets or with assets held by a business unit outside of the catalog module. In the exemplary embodiment, module 168 includes a transformation module 168A, a concordance module 168B, and an orchestration module 168C.

Orchestration module 168A performs functions related to work-flow management, content aggregation and orchestration. In the exemplary embodiment, standardizing the orchestration technology eliminates or reduces the need for individual business units to develop or purchase orchestration tools using the orchestration functions inherent in the module.

Concordance module 168B performs vocabulary mapping of data dictionaries when content is aggregated. This function enables automated concordance once a business unit has registered its asset in the catalog module and incorporated the services data dictionary into the concordance module. Individual solutions entail creation of data dictionary maps.

Transformation module 168C includes a transformation engine that can handle both on-the-fly transactional data transformation, or long running batch processes to facilitate the movement and aggregation of large content sets. In some embodiments, this module translate from XML to HTML, or converts functions from transactional to batch.

Although not shown explicitly in FIG. 1, components of collaborative infrastructure 160 as well as linkage of the infrastructure to the business units is achieved using network communications. In the exemplary embodiment, the network incorporates TCP/IP and VPN related security, such as firewalls, proxies, tunneling, routers, gateways etc.

### Exemplary Method of Operation

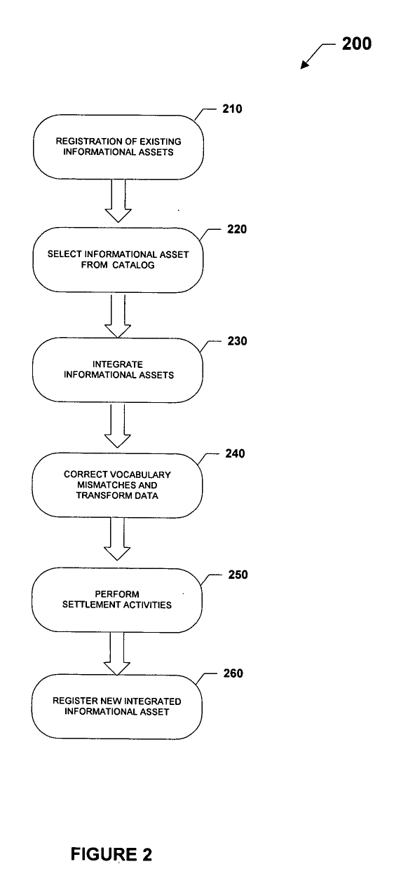

FIG. 2 shows a flow chart 200 of one or more exemplary methods of operating a system, such as system 100. Flow chart 200 includes blocks 210-260, which are arranged and described in a serial sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow applies to software, hardware, and firmware implementations.

In block 210, the exemplary method begins with registration of content or services in a catalog. In the exemplary embodiment, this entails two or more business units each registering or allowing the registration of one or more information assets with catalog module 162. In some embodiments, this registration may entail registration with a business unit catalog and mirroring that registration into catalog module 162. In some embodiments, the registration adheres to a version of UDDI standard. In any event, this initial registration step allows for the future “discovery” of the asset by one or more authorized product developer of one or more of the business units. Execution continues at block 220.

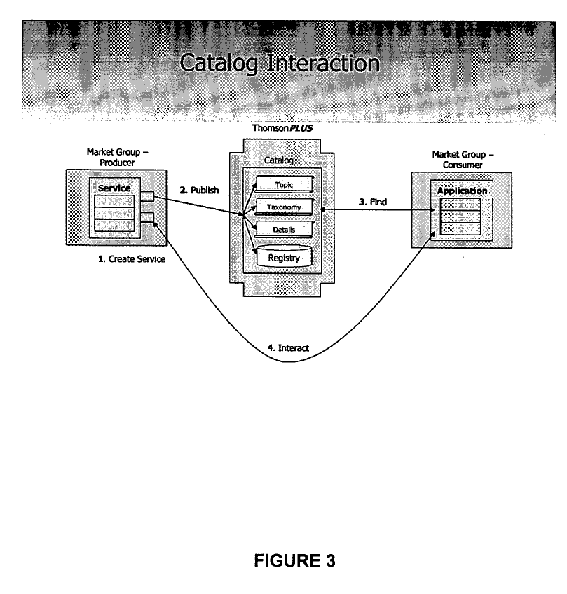

Block 220 entails a user, for example, a product developer, for at least one participating business unit, selecting one or more informational assets from catalog module 162. In the exemplary embodiment, this entails authentication and authorization of a user, allowing the user to define and submit queries against the contents of catalog, and then to select one or more informational assets from search results. FIG. 3 shows one exemplary form of interaction with an informational asset catalog. Execution then advances to block 230.

Block 230 entails aggregating or integrating multiple offerings. In the exemplary embodiment, this integration entails use of orchestration module 168A. In the exemplary embodiment, Execution then advances to block 240.

Block 240 entails correcting any vocabulary mismatches between aggregated content using the concordance module 168B. Block and data formats transformed into a format that can be consumed by a presentation layer created by the participating business unit. Execution proceeds to block 250.

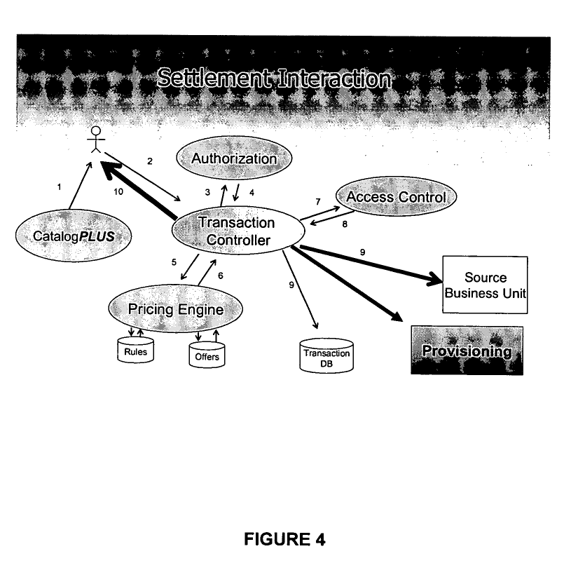

Block 250 entails settling the financial terms for usage of the informational assets. In the exemplary embodiment, this entails applying royalty or usage fees or other financial terms against and to business accounts associated with the relevant business units and updating account ledges and so forth to reflect the transaction. In some embodiments, prices or royalties are arranged to distinguish development from actual roll out of a commercially viable integrated solution. FIG. 4 shows one exemplary from of settlement activity. Execution advances to block 260.

Block 260 entails registering the newly created integrated asset into the catalog for use by other entities. In the exemplary embodiment, the new created asset is stored in the producing business entity, with an appropriate pointer in the catalog module. However, other embodiments may store the asset in the catalog.

### Conclusion

In furtherance of the art, the present inventors have identified a need for and presented herein better ways of leveraging information and related solutions across multiple business units.

For example, the present inventors have devised a computerized implementation of a federated business model and architecture for the creation of integrated information solutions from content sets and service offerings provided by multiple business units. The exemplary system includes a catalog module that facilitates identification of informational assets, such as products, services, and content, that are created by multiple business units; a collaborative infrastructure to facilitate aggregation or integration of two or more informational assets into a new informational asset; and a settlement module for handling one or more financial and accounting aspects of the asset integration.

The embodiments described above are intended only to illustrate and teach one or more ways of making and using the present invention, not to restrict its breadth or scope. The actual scope of the invention, which embraces all ways of practicing or implementing the teachings of the invention, is defined only by one or more issued patent claims and their equivalents.

1. A system comprising:
a plurality of business units, each having a corresponding set of information-related products, services, and content; and
a collaborative infrastructure electronically couplable via a network to each of the business units, the infrastructure including:
a catalog module for discovering and accessing services or content of each of the business units;
a performance module for monitoring performance of collaborative infrastructure;
an integration module for facilitating transfer or sharing of information-related products, services, and content of one or more of the business units with one or more others of the business units; and
a settlement module for settling transfer prices between business units that provide informational-related products, services, or content and business units that receive provided informational-related products, services or content from providing business units.

2. The system of claim 1, wherein two or more of the business units are subsidiaries of a common business entity.

3. The system of claim 1, wherein at least two of the business units are independent business entities.

4. The system of claim 1, wherein the plurality of business units includes:
at least one of a legal information business, a learning business, a financial information business, and a scientific information business; and
at least another of a legal information business, a learning business, a financial information business, and a scientific information business.

5. The system of claim 4, wherein the legal publishing business provides information and solutions to legal, tax, accounting, intellectual property, or compliance professionals.

6. The system of claim 4, wherein the learning business provides learning products, services and solutions to individuals, post secondary learning institutions, or businesses.

7. The system of claim 4, wherein the financial information business provides information and workflow solutions to the worldwide financial community.

8. The system of claim 4, wherein the scientific information business provides integrated information, services and solutions to researchers and other professionals in the healthcare, academic, scientific and governmental marketplaces.
